(19) United States
(12) Patent Application Publication
(10) Pub. No.: US 2016/0198018 A1
(43) Pub. Date: Jul. 7, 2016

(54) MOBILE DEVICE FOR EXECUTING RADIO APPLICATION

(71) Applicant: INDUSTRY-UNIVERSITY COOPERATION FOUNDATION HANYANG UNIVERSITY, Seoul (KR)

(72) Inventors: Seung Won CHOI, Seoul (KR); Chi Young AHN, Bucheon-si, Gyeonggi-do (KR); Hyun Wook YANG, Seoul (KR); Yong KIM, Seoul (KR)

(21) Appl. No.: 14/785,458

(22) PCT Filed: Apr. 18, 2014
(86) PCT No.: PCT/KR2014/003392

§ 371 Date: Jan. 28, 2016

(30) Foreign Application Priority Data
Apr. 19, 2013 (KR) 10-2013-0043416
Apr. 18, 2014 (KR) 10-2014-0046370

(51) Int. Cl. H04L 29/08; H04L 12/721; H04W 72/04

(52) U.S. Cl. CPC H04L 67/34; H04W 72/0453; H04L 45/38; H04W 88/02

(57) ABSTRACT

Disclosed is a mobile device for executing a radio application (RA) along with a radio interface. The mobile device for executing a radio application includes: a communication service layer (CSL) operated in an application processor or a radio processor for providing at least one of an application administration service, an access control service and a dataflow service; a radio control framework (RCF) operated in the application processor or the radio processor for providing the operational environment of the radio application in linking with the communication service layer; and a multi radio interface (MURI) for enabling the communication service layer to interact with the radio control framework.

### TECHNICAL FIELD

The present invention relates to a software defined radio (SDR) technology, a digital wireless communication technology, a radio processor (RP) technology, an application processor (AP) technology, and a multi-radio application.

Particularly, the present invention relates to a structure of a multi radio interface (MURI) for controlling a radio application (RA). More particularly, the present invention relates to a structure of a terminal apparatus including the MURI for controlling multiple RAs independently on hardware, and the MURI.

### BACKGROUND ART

As communication technology advances, various new kinds of radio applications are being used as adapted for tastes and objectives of users. The most of radio applications, such as a Long Term Evolution (LTE), a Wide-band Code Division Multiple Access (WCDMA), a Worldwide Interoperability for Microwave Access (WiMAX), a Global System for Mobile Communications (GSM), may operate on radio terminals by interworking with a modem embedded in the radio terminal.

Modems embedded the radio terminal may have instruction sets unique for each manufacturer, and implement respective radio communication technologies by using the unique instruction sets. In order to make it possible that a radio application controls the modem, a customized module should be developed based on understanding unique instructions of each modem designed by various modern manufactures or having various models. This situation leads to a result that a specific application can be executed on a specific modem designed by a specific manufacturer, or even on a specific model of modem designed by the specific manufacturer. To overcome the above-mentioned problem, different control instruction codes customized for various kinds of modems should be comprised in the radio application, or different executable file for each modem should be built and distributed.

However, since it is practically impossible to optimize the radio application to all the various kinds of modem hardware currently available in the market currently by the above-mentioned methods, there is a problem that a great manpower is needed to develop a radio application.

In order to resolve the above-described problems, there were attempts to produce hardware-independent multi radio applications by using unified instruction sets instead of instruction sets unique for respective manufacturers.

Also, a technology which can convert a manner in which each of a radio base station and a terminal apparatus supports radio frequency (RF) through hardware into a manner in which each of the radio base station and the terminal apparatus supports RF through software. That is, a software defined radio (SDR) technology can make it possible that a single apparatus can support multiple modes, multiples bands, and multiple environments without being restricted to a specific location or time.

If a SDR module is installed in a portable terminal such as a mobile phone, a personal digital assistant (PDA), and a laptop computer, the SDR module can make it possible that the terminal supports different frequency bands and two or more systems. That is, the SDR technology can provide a new communication manner for various wireless networks, various wireless communication systems, various frequency bands, and high-speed data communications in a fourth generation communication pursuing an all internet protocol (All-IP) based wireless multimedia communications.

In connection with the software defined radio (SDR) technology, there exists a software communication architecture (SCA) which is a defacto standard technology. It may comprise specifications related to frameworks for SDR, middleware, and real-time operating system (OS), which guarantees compatibility of interfaces between SDR systems. The core of SCA is a core framework which is a framework specification. In the core framework, various parts constituting radio applications are componentized and the components may be reused and assembled so as to create a new radio application. In case of SCA, it is possible to make rearrangement of blocks which are already installed in a terminal. However, user-defined blocks to be used for a specific radio application cannot be installed even into SCA compatible terminals having different hardware configurations. Thus, single executable codes cannot be used for all SCA compatible terminals.

This means that executable codes optimized for each hardware configuration on which each SCA compatible terminal is based should be respectively created and distributed. This demands very much time and cost, and makes commercial uses of radio applications difficult, Also, it does not provide baseband application programming interface (API) for implementation of radio applications, and accordingly it makes selective utilization of hardware acceleration functions difficult.

### DISCLOSURE

### Technical Problem

The purpose of the present invention for resolving the above-described problems is to provide a terminal apparatus executing a radio application which is independent on hardware.

Also, the purpose of the present invention is to provide an interface method of functionally separating various components operating in a processor of the terminal apparatus, and making it possible that various components can interwork.

### Technical Solution

In order to achieve the above-described purpose, a terminal apparatus according to an exemplary embodiment of the present invention, which executes a radio application (RA) and includes an application processor (AP) and a radio processor (RP), may comprise a communication service layer (CSL) operating on the AP or the RP, and providing at least one of an administrative service, an access control service, and a data flow service for the RA; a radio control framework (RCF) operating on both of the AP and the RP or on the RP, and providing operation environments for the RA by interworking with the CSL; and a multi radio interface (MURI) for interworking of the CSL and the RCF.

Here, the MURI may be provided as a multi radio subsystem.

Here, the CSL may comprise at least one of an administrator performing at least one of installation/uninstallation of the RA, creating/deleting an instance of the RA, and a request of list information and status information of RAs; a mobility policy manager (MPM) monitoring capabilities and radio environments of the terminal apparatus, and selecting at least one of two or more radio access technologies (RATs); a networking stack sending and receiving user data; and a monitor transmitting context information.

Here, the RCF may comprise at least one of a configuration manager (CM) performing installation/uninstallation of the RA, creating/deleting an instance of the RA, and access management of radio parameters for the RA; a radio connection manager (RCM) performing activation/deactivation of the RA and management of user data flow switching between RAs; a flow controller (FC) controlling sending/receiving and a flow of user data packets; a multi-radio controller (MRC) scheduling requests for spectrum resources issued by the RA; and a resource manager (RM) managing radio resources to share them among RAs.

Here, the MURI may comprise at least one of an administrative service performing management of the RA, an access control service controlling activation/deactivation of the RA; and a data flow service providing a function of transferring user data of the terminal apparatus or user data received at the terminal apparatus.

In addition, the administrative service may transfer a request of installation or uninstallation of the RA from the CSL to the RCF, transfer confirmation for the request of installation or uninstallation from the RCF to the CSL, and control the RCF to install or uninstall the RA based on the request of installation or uninstallation. In addition, the administrative service may transfer at least one of a request of creating or deleting an instance of the RA, a request of parameter configuration, and a request of list information of RAs from the CSL to the RCF, and transfer at least one of confirmation for the request of creating or deleting an instance of the RA, confirmation of the request of parameter configuration, retrieved list information, and information indicating a failure for the at least one request from the RCF to the CSL.

In addition, the access control service may transfer a request of activation or deactivation of the RA from the CSL to the RCF, transfer confirmation for the request of activation or deactivation from the RCF to the CSL, and control the RCF to activate or deactivate the RA based on the request of activation or deactivation.

In addition, the access control service may transfer at least one of a request of list information of RAs, a request of measurements for radio environments, a request of measurements for the terminal apparatus capabilities, a request of creating a data flow, and a request of network and logical radio link association from the CSL to the RCF, and transfer at least one of retrieved list information, information on the radio environments, information on the terminal apparatus capabilities, confirmation for the request of creating a data flow, confirmation for the network and logical radio link association, and information indicating a failure of the at least one request from the RCF to the CSL.

Also, the data flow service may transfer the user data of the terminal apparatus from the CSL to the RCF, or transfer the user data received at the terminal apparatus from the RCF to the CSL.

In addition, the data flow service may transfer information indicating a failure of the user data transfer from the RCF to the CSL.

Here, the RA may comprise standard function blocks (SFBs) which call function blocks implemented using dedicated hardware logics included in the RP or which operate on a core of the RP; user-defined function blocks (UDFBs) which are not provided as the SFBs or which are customized from functions provided by the SFBs; and a radio controller code performing a function of transmitting context information to a monitor of the CSL or a function of exchanging data with a networking stack of the CSL. In addition, the RA may be distributed in a form of a radio application package (RAP) comprising at least one of the SFBs; the UDFBs; the radio controller code; and a pipeline configuration meta data defining relations among the SFBs, the UDFBs, and the radio controller code.

In addition, the radio application package may further comprise a radio library including the SFBs.

In order to achieve the above-described purpose, a method of executing a radio application (RA), performed in a terminal apparatus including an application processor (AP) and a radio processor (RP), may comprise providing at least one of an administrative service, an access control service, and a data flow service for the RA in a communication service layer operating on the AP or the RP; providing operation environments for the RA by interworking with the CSL in a radio control framework (RCF) operating on both of the AP and the RP or on the RP; and providing a multi radio interface (MURI) for interworking of the CSL and the RCF.

In order to achieve the above-described purpose, a multi radio subsystem providing a multi radio interface (MURI) operating in a terminal apparatus executing a radio application (RA) may be provided. Also, the MURI may provide functions for interworking of a communication service layer (CSL) operating on an application processor (AP) or a radio processor (RP) and a radio control framework (RCF) operating on the AP or the RP. Also, the CSL may provide at least one of an administrative service, an access control service, and a data flow service of the RA for the RA, and the RCF may provide operating environments for the RA by interworking with the CSL.

In addition, the multi radio subsystem may provide at least one of an administrative service performing management of the RA, an access control service controlling activation/deactivation of the RA, and a data flow service providing a function of transferring user data of the terminal apparatus or user data received at the terminal apparatus.

In addition, the administrative service may transfer at least one of a request of installation or uninstallation of the RA, a request of creating or deleting an instance of the RA, a request of list information of RAs, and a request of status information of RAs from an administrator of the CSL to the RCF.

In addition, the administrative service may control a configuration manager of the RCF to perform installation or uninstallation of the RA and creation or deletion of an instance of the RA based on the request, and transfer confirmation for the installation, uninstallation, creation, or deletion from the configuration manager to the administrator.

Also, the access control service may transfer at least one of a request of list information of RAs, a request of measurements for radio environments, a request of measurements for the terminal apparatus capabilities, a request of creating a data flow, and a request of network and logical radio link association from the CSL to the RCF such that a mobility policy manager (MPM) of the CSL monitors capabilities and radio environments of the terminal apparatus and selects at least one of one or more radio access technologies (RATs).

### Advantageous Effects

Using the above-described terminal apparatus including a multi radio interface (MURI) according to the present invention and a multi radio subsystem for the same, it is made possible that various radio applications can be used independently of hardware platforms of terminal apparatuses.

In addition, in aspect of mobile operators, it may become possible to switch radio access technologies of which terminals based on various radio platforms that subscribers are using into desired radio access technologies according to their needs so that flexible operation of mobile networks may be possible.

In addition, in aspect of subscribers, it may become possible that they can use new radio access technologies only by downing a radio application package for a desired radio application and installing the desired radio application in their terminals without purchasing new terminals.

### DESCRIPTION OF DRAWINGS

FIG. 1 is a conceptual diagram showing an example in which a radio application according to an embodiment of the present invention is available in an online store.

FIG. 2 is a block diagram illustrating a multi radio subsystem according to an exemplary embodiment of the present invention and relations among the multi radio subsystem and components interworking with the multi radio subsystem.

FIG. 3 is a block diagram explaining a case in which a communication service layer operates on an application processor layer, and a radio control framework operates on both of an application processor layer and a radio processor layer, in a software architecture environment where a radio application according to an exemplary embodiment of the present invention.

FIG. 4 is a block diagram explaining a case in which both of a communication service layer and a radio control framework operate on a radio processor layer, in a software architecture environment where a radio application according to an exemplary embodiment of the present invention.

FIG. 5 is a diagram illustrating an overall architecture of a mobile device with all reference points specified in between corresponding components.

FIG. 6 is a diagram illustrating reference points for installation/uninstallation and creating/deleting an instance of a radio application according to an exemplary embodiment of the present invention.

FIG. 7 is a diagram illustrating reference points for obtaining lists of radio applications according to an exemplary embodiment of the present invention.

FIG. 8 is a diagram illustrating reference points for activation/deactivation of radio application according to an exemplary embodiment of the present invention.

FIG. 9 is a diagram illustrating reference points for transferring context information according to an exemplary embodiment of the present invention.

FIG. 10 is a diagram illustrating reference points for creating data flow and sending/receiving user data according to an exemplary embodiment of the present invention.

FIG. 11 is a block diagram explaining a configuration example of components and interface objects constituting a MURI according to an exemplary embodiment.

FIG. 12 is a conceptual diagram to explain a RP layer software architecture of radio applications according to the present invention.

FIG. 13 is a hierarchical structure diagram to explain an example of operational structure of unified radio applications according to an exemplary embodiment of the present invention.

FIG. 14 is a hierarchical structure diagram to explain another example of operational structure of unified radio applications according to an exemplary embodiment of the present invention.

FIG. 15 is a conceptual diagram to explain implementations of function block libraries of a given radio platform according to the present invention.

FIG. 16 is a block diagram to explain a configuration example of a radio application package according to the present invention.

### BEST MODE

The present invention may be variously modified and may include various embodiments. However, particular embodiments are exemplarily illustrated in the drawings and will be described in detail. However, it should be understood that the particular embodiments are not intended to limit the present disclosure to specific forms, but rather the present disclosure is meant to cover all modification, similarities, and alternatives which are included in the spirit and scope of the present disclosure. Like reference numerals refer to like elements throughout the description of the drawings.

Relational terms such as first, second, A, B, and the like may be used for describing various elements, but the elements should not be limited by the terms. The terms are used solely for distinguishing one element from another. For instance, without departing the scope of the present disclosure, a first element may be named as a second element, and similarly, a second element may be named as a first element. The term “and/or” encompasses both combinations of the plurality of related items disclosed and any item from among the plurality of related items disclosed.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is not for delimiting the present invention but for describing the specific embodiments. The terms of a singular form may include plural forms unless otherwise specified. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Terminologies used for explaining the present invention are defined as follows. Other terminologies except the following terminologies will be defined in the corresponding parts of the present specification.
Radio Application (RA): an application which provides a radio communication environment independent on specific hardware configurations and user applications. The radio application may be executed on a radio processor. Alternatively, the radio application may be configured to comprise a part which is executed on a radio processor and a part which is executed on an application processor, and to operate on the two processors. The radio application may comprise a radio controller and function blocks. The function blocks may include standard function blocks and user defined function blocks.
Radio Application Package (RAP): As a distribution form of a radio application, a RAP may include a radio controller and function blocks which are components of the radio application, and also include pipeline configuration metadata. In addition, the radio application package may further include a radio library.
Standard Function Block (SFB): It is a standardized function block each of which has a standardized function and a standardized function name used for calling the function. In case that radio platform chip vendors develop the standard function blocks, the standard function blocks may be a set of function blocks implemented by the vendors, and may be provided with a driver used for driving the blocks. The standard function blocks may be implemented by using a dedicated hardware accelerator, or implemented as executable codes to be executed on a radio processor core. If the standard function blocks are implemented as executable codes to be executed on a radio processor core, a set of the standard function blocks may be referred to as a radio library. Each of the standard function blocks has standardized name and feature for its function, and may be defined by using a standard baseband Application Programming Interface (API) header.
User-Defined Function Block (UDFB): It is a function block which can be provided by radio application providers. A UDF may have a function which is not provided as a standard function block or a function which is customized from an existing standard function block. It may be implemented to be executed on a radio processor core. The user-defined function blocks may be provided in forms of executable codes, source codes, or intermediate representation (IR) codes.
User Defined Function Block (UDFB) set: A set of user-defined function blocks which are provided by radio application providers.
Radio Hardware Abstract Layer (HAL): It is a layer abstracting various kinds of hardware in aspect of an operating system (OS). Since standardized abstract interfaces of accelerator are independent on hardware, HAL enables OS to access all types of hardware. A role of HAL is similar to a role of driver. However, HAL is included in OS differently from drivers which may change according to hardware changes.
Radio Platform Driver: It is software needed for OS to recognize hardware. This is software matching OS instructions which are independent on hardware with hardware-instructions, and may act as a usual hardware driver.

Hereinafter, preferred embodiments according to the present invention will be described in detail with reference to the accompanying drawings. In describing the invention, to facilitate the entire understanding of the invention, like numbers refer to like elements throughout the description of the figures, and a repetitive description on the same element is not provided.

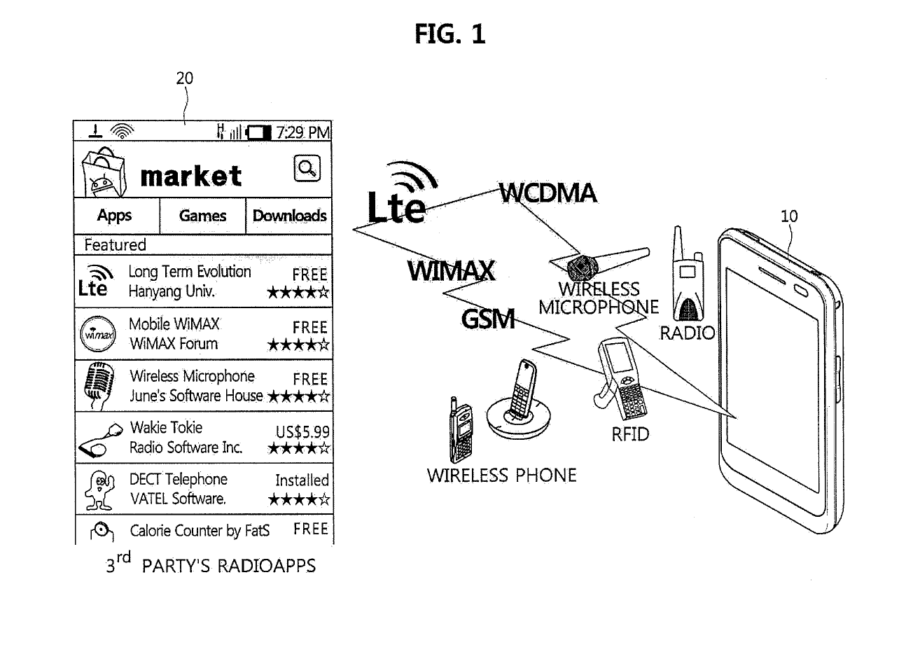

FIG. 1 is a conceptual diagram showing an example in which a radio application according to an embodiment of the present invention is available in an online store.

Referring to FIG. 1, a user may access an on-line app store 20 via a terminal 10, select a desired radio application in a list of radio applications provided by the on-line app store, which support various radio access technologies, and download a radio application package corresponding to the selected radio application.

The various radio access technologies may include Long Term Evolution (LTE), Wideband Code Division Multiple Access (WCDMA), Worldwide Interoperability for Microwave Access (WiMax), Global System for Mobile Communications (GSM), Radio-Frequency Identification (RFID), and so on. The user may freely select a radio application to be used situationally among a plurality of radio applications which have been downloaded and installed in the terminal.

Terminal Apparatus and its Software Architecture

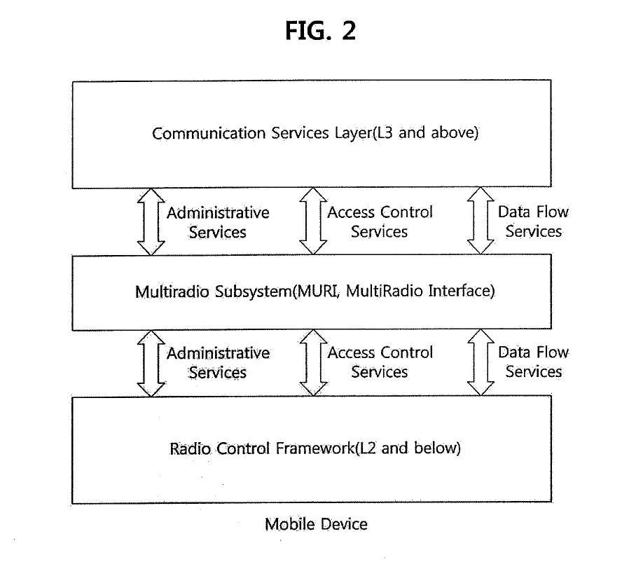

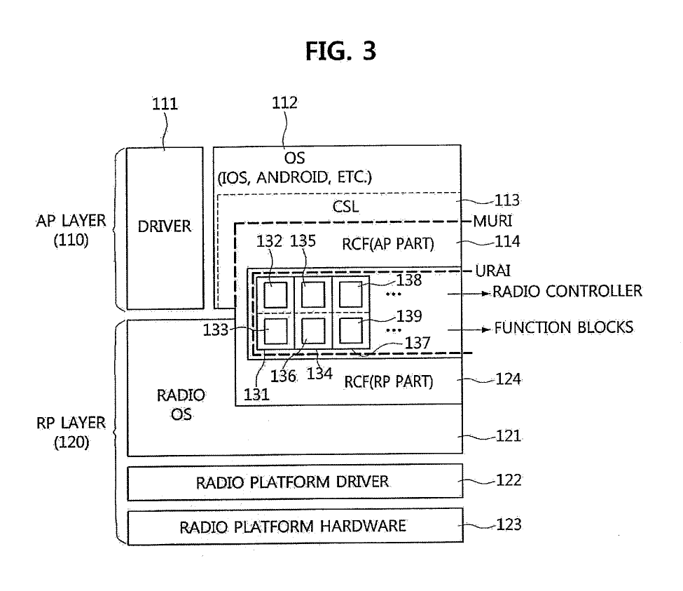

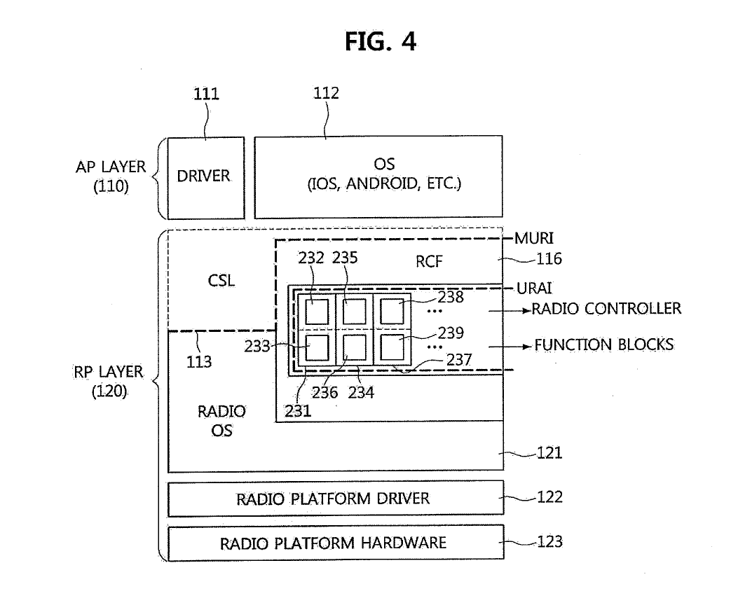

FIG. 2 is a block diagram illustrating a multi radio subsystem according to an exemplary embodiment of the present invention and relations among the multi radio subsystem and components interworking with the multi radio subsystem. FIG. 3 and FIG. 4 illustrate software architecture environments on which a radio application operates. That is, FIG. 3 illustrates a case in which a communication services layer (CSL) operates in an application processor (AP) layer and a radio control framework (RCF) operates in both of the AP layer and a radio processor (RP) layer. Also, FIG. 4 illustrates a case in which both of the RCF and the CSL operate in the RP layer.

Referring to FIGS. 2 to 4, operations of a terminal apparatus, components constituting the terminal apparatus, such as a communication service layer, a multi radio subsystem, and a radio control framework, and component interworking with such the components will be described as follows.

A multi radio interface (MURI) is an interface defined between a communication service layer and a radio control framework. FIG. 2 shows how the CSL and the RCF interwork by using the MURI. As shown in FIG. 2, the MURI supports three services. The three services may include an administrative service, an access control service, and a data flow service. Also, the CSL constitutes a layer 3 and layers above the layer 3, and the RCF constitutes a layer 1 and a layer 2.

Referring to FIG. 3 and FIG. 4, a radio software architecture according to the present invention may comprise an AP layer 110 which operates on an application processor (AP) and a RP layer 120 which operates on a radio processor (RP). Here, the RP may be also referred to as a baseband processor (BP).

FIG. 3 illustrates a software architecture environment where a RCF, which is described later, is divided into two parts—a part being executed on the AP (referred to as an AP layer part) and a part being executed on the RP (referred to as a RP layer part), and executed on the two processors. Also, FIG. 4 illustrates a software architecture environment where a RCF is executed only on the RP.

A non-real time OS such as Andriod OS of Google, iOS of Apple, etc. may operate on the AP, and a real time OS (hereinafter, referred to as a ‘radio OS’) may operate on the RP. Hereinafter, for clear discrimination, the non-real time OS operating on the AP layer may be referred to as ‘OS’, and the real time OS operating on the RP layer may be referred to as ‘radio OS’.

Hereinafter, the AP layer, the RP layer, and components constituting the RCF will be described in detail.

(1) Application Processor Layer

The AP layer comprises the following components, as shown in FIG. 3 and FIG. 4.

Drivers 111 drive hardware devices (e.g., a camera, a speaker, etc.) on a given OS.

OS 112 means non-real time OS (e.g., Android and iOS) operating in general mobile devices.

If the RCF is configured to operate on the AP and the RP both (as shown in FIG. 3), an AP layer part 114 of the RCF may exist on the OS. If the RCF is configured to operate only on the RP (as shown in FIG. 4), the RCF does not exist on the AP layer.

If the RCF operates on both the processors (a composition of FIG. 3), a CSL 113 may exist on the OS of the AP.

The CSL may be a layer providing at least some of the following three services to the RCF.

The first service is related to an administrative. It may be a service related to installation/uninstallation of radio applications, creating/deleting instance of radio applications, and acquisition of a list of radio applications in each status (installed, instanced, activated).

The second service is related to connection control. It may be a service related to activation/deactivation of radio applications, creation of data flow, creation of network allocation, and acquisition of a list of radio applications in each status (installed, instanced, activated).

The third service is related to data flow. That is, this service is a service related to sending/receiving user data.

As an example of CSL configurations for providing at least some of the above-described three services, the CSL may be configured to comprise an administrator application, a mobility policy manager application, a networking stack (i.e., a protocol stack operating in the CSL), and a monitor application.

However, the CSL may comprise only some of the above-described components, and may further comprise additional components as well as the above-described components. Also, one or more components among the above components may be integrated into a single component existing within the CSL. Also, the above-described components are only examples of components which the CSL can comprise in order to support services which should be performed by the CSL. That is, the CSL may be defined based on functions performed by it. The above-described exemplary composition of components does not restrict composition of the CSL.

In the configuration in which the RCF operates on both the AP and the RP (the composition of FIG. 3), radio applications 131, 134, and 137 may respectively comprise AP layer parts 132, 135, and 138 and RP layer parts 133, 136, and 139. A radio controller (RC) which is the AP layer part of radio application may be configured to transmit context information to the monitor application of the CSL, transmit data to the networking stack of the CSL, and receive data from the networking stack.

(2) Radio Processor Layer

The radio processor layer comprises the following components, as shown in FIG. 3 and FIG. 4.

A radio OS 121 is a real time operation system.

If the radio control framework is configured to operate on both the AP and the RP (as shown in FIG. 3), a RP layer part 115 of the RCF may exist on the radio OS.

If the RCF operates only on the RP (as shown in FIG. 4), the RCF does not exist on the AP layer. That is, the RCF 230 exists only on the RP layer.

If the RCF exists only on the radio processor (as shown in FIG. 4), the CSL 113 exists on the radio OS 221. However, without being restricted to the example of FIG. 4, also for the case in which the RCF operates only on the RP, the CSL may be configured to operate in the AP layer.

Since role and configuration of the CSL 113 illustrated in FIG. 4 are identical to those of the CSL 113 illustrated in FIG. 3, redundant explanations are omitted.
Radio platform drivers 122 are components demanded for the radio OS to recognize a hardware radio platform similarly to usual hardware drivers.
Radio platform hardware 123 may be configured as core(s) of the RP and baseband accelerators.

The baseband accelerators prepared for the standard function block(s) may usually be provided in form of application-specific integrated circuit (ASIC).

If the RCF is configured to operate only on the RP (i.e. a configuration shown in FIG. 4), radio applications 231, 234, and 237 may be executed on the RP layer.

Radio controllers 132, 135, and 138 of respective radio applications may be configured to transmit context information to the monitor application of the CSL, transmit data to the networking stack of the CSL, and receive data from the networking stack.

A multi-radio interface (MURI) is an interface between the CSL and the RCF, and a unified radio application interface (URAI) is an interface between the radio application and the RCF.

A radio application is an application enabling communications of a mobile terminal, and may be distributed in form of a radio application package (RAP). Components of a RAP may be configured as follows.

1) User Defined Function Block (UDFB)

2) Pipeline configuration metadata

3) Radio controller code (RC code)

4) Radio library—a radio library is distributed in form of executable codes as included in a RAP, when the standard function blocks (SFB) are distributed as executable codes.

The RAP may be downloaded onto the OS of the AP layer, and the user-defined function block codes and the radio library may be loaded from the AP to the RP by referring to the pipeline configuration metadata, and finally loaded to the radio OS on the RP layer.

(3) Radio Control Framework

The radio control framework (RCF) 130 or 230 is a component for providing operation environment of radio applications.

If the RCF is configured to operate on both the AP and the RP (as shown in FIG. 3), components of the RCF may be classified into two groups 114 and 124. That is, one group operates on the AP, and other group operates on the RP. Which components of the RCF operate on the RP (i.e. in real-time) and which components of the RCF operate on the RP (i.e. in non-real-time) may be determined differently by each vendor.

If the RCF is configured to operate only on the RP (i.e. a configuration of FIG. 4), the RCF exists only on the RP layer without discrimination of a RP layer part and an AP layer part.

Basically, the RCF may include at least some of the following 5 components for managing radio applications.

However, the RCF may comprise only some of the following 5 components, and may further comprise additional components as well as the following 5 components. Also, one or more components among the following components may be integrated into a single component existing within the RCF.

The role of the RCF may be defined based on functions performed by the components which will be described. The following exemplary components do not restrict composition of the RCF. That is, the RCF may have various configurations for performing at least some of functions of the following components.

1) Configuration Manager (CM): Installation/un installation and creating/deleting instance of RAs for a multi radio terminal apparatus as well as access management of radio parameters for RAs.

2) Radio Connection Manager (RCM): Activation/deactivation of RAs according to user requests, and overall management of user data flows, which can also be switched from one RA to another.

3) Flow Controller (FC): Sending and receiving of user data packets and controlling the flow of signaling packets.

4) Multiradio Controller (MRC): Scheduling the requests for radio resources issued by concurrently executing RAs and detecting and managing the interoperability problems among the concurrently executing RAs.

5) Resource Manager (RM): Managing multi-radio resources to share them among simultaneously active RAs, and to guarantee their real-time requirements.

Software Architecture Reference Points

Hereinafter, procedures of interfacing between a RCF and a RA for embodying installation/uninstallation, creating/deleting of instances, and operations of the unified radio application will be explained as examples.

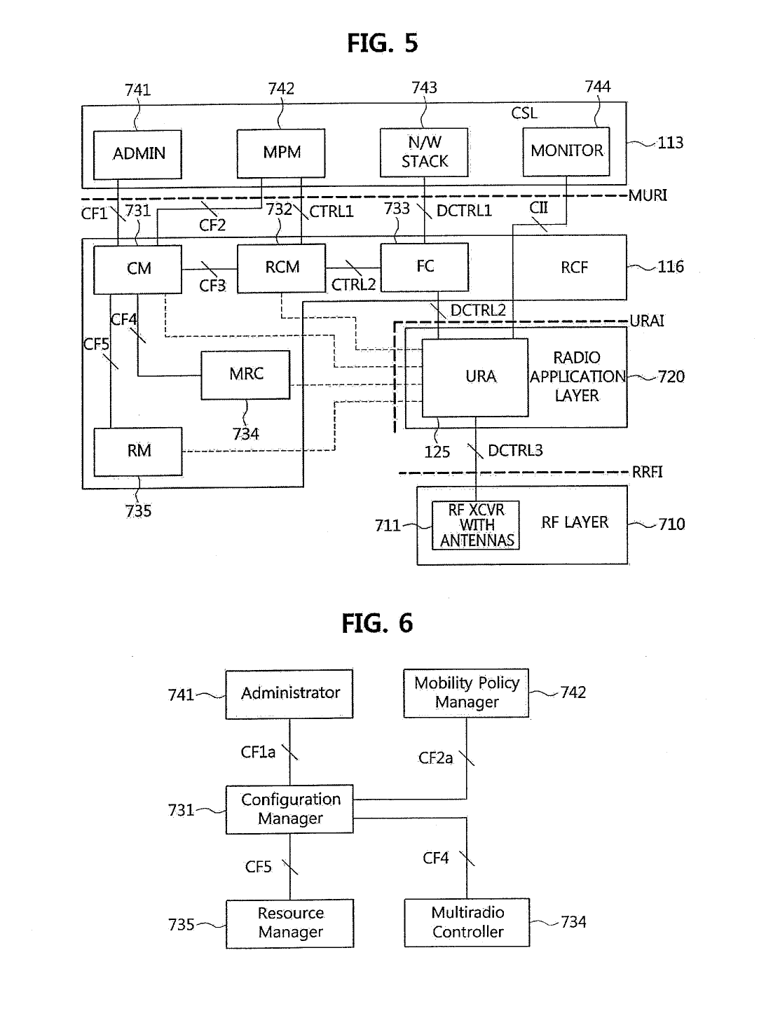

FIG. 5 is a diagram illustrating an overall architecture of a mobile device with all reference points specified in between corresponding components.

In FIG. 5, each solid line between two blocks denotes a reference point defined between the two blocks through which direct interactions between the two blocks are performed. Also, each dotted line between two blocks denotes that interactions between the two blocks are performed through radio OS based on commands issued by a corresponding block. As will be explained later, blocks in RCF (i.e. CM, RCM, MRC, and RM) issue the command for the interaction to take place at the unified radio application through the radio OS.

The definition of each reference point is based on the three kinds of interfaces—MURI which are interfaces between components of communication services layer and those of RCF, URAI which are interfaces between URA and component of RCF, and Reconfigurable Radio Frequency Interfaces (RRFI) which are interfaces between URA and Radio Frequency (RF) part. In addition to MURI, URAI, and RRFI, interfaces between components of RCF have also been defined as reference points. In the present document, we classify the reference points according to procedures of their functions such that the classification of each of the reference points becomes coincident with each of the procedures which will be described later.

(1) Reference Point 1: Interfaces for Installation/Uninstallation and Creating/Deleting Instance of RA

FIG. 6 is a diagram illustrating reference points for installation/uninstallation and creating/deleting an instance of a radio application according to an exemplary embodiment of the present invention.

Referring to FIG. 6, CF1a is an interface between an administrator and a configuration manager (CM), which is for the administrator to request CM to perform installing, uninstalling of RA or for the administrator to receive response of the request from CM.

CF2a is an interface between a mobility policy manager (MPM) and CM, which is for MPM to request CM to perform creating instance or deleting instance of RA or for MPM to receive response of the request from CM.

CF4 is an interface between CM and a multiradio controller (MRC), which is for CM to request MRC to send parameters related to radio resources to CM, or for CM to receive response of the request (i.e. the parameters related to radio resources) from MRC during the procedure of creating instance of RA.

CF5 is an interface between CM and a resource manager (RM), which is for CM to request RM to send parameters related to computational resources to CM, or for CM to receive response of the request (i.e. the parameters related to computational resources) from RM during the procedure of creating instance of RA.

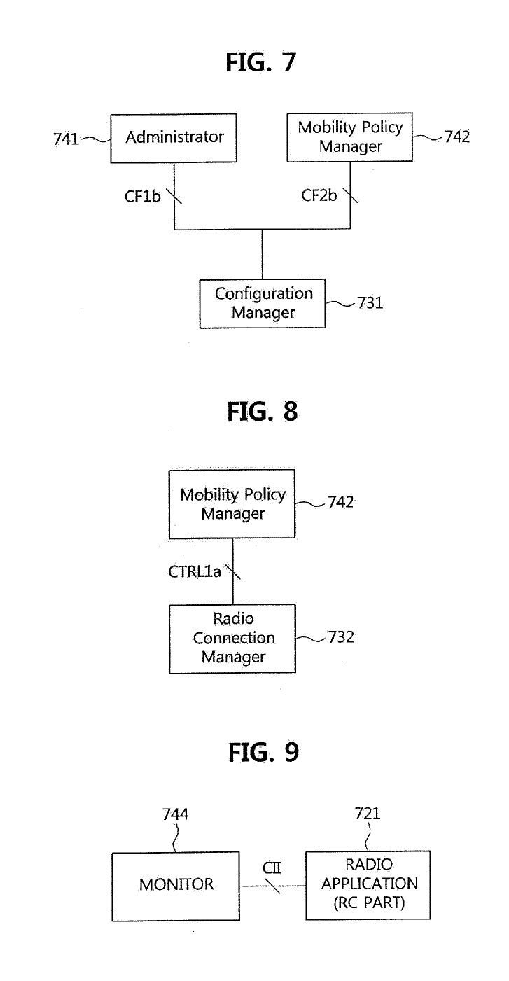

(2) Reference Point 2: Interfaces for list checking of radio applications FIG. 7 is a diagram illustrating reference points for obtaining lists of radio applications according to an exemplary embodiment of the present invention.

Referring to FIG. 7, CF1b is an interface between the administrator and CM, which is for the administrator to request CM to send the RA list to Administrator, or for Administrator to receive response of the request (i.e. the RA list) from CM.

Reference Point CF2b is an interface between MPM and CM, which is for MPM to request CM to send the RA list to MPM, or for MPM to receive response of the request (i.e. the RA list) from CM.

(3) Reference Point 3: Interfaces for Activation/Deactivation of Radio Application.

FIG. 8 is a diagram illustrating reference points for activation/deactivation of radio application according to an exemplary embodiment of the present invention.

Referring to FIG. 8, CTRL1a is an interface between the MPM and a radio connection manager (RCM), which is for MPM to request RCM to perform activation/deactivation of RA, or for MPM to receive response of the request (i.e. activation/deactivation of RA) from RCM.

(4) Reference Point 4: Interfaces for transferring context information FIG. 9 is a diagram illustrating reference points for transferring context information according to an exemplary embodiment of the present invention.

Referring to FIG. 9, CII is an interface between the monitor and RC in RA, which is for Monitor to request RC in RA to send context information to the monitor, or for the monitor to receive response of the request (i.e. the context information) from RC in RA.

The context information is generated from corresponding function block(s) of RA(s) and transferred to RC. There should be interfaces between RC within a radio application and each of corresponding function blocks. This means that baseband interface (BBI) for transferring context information between the RC and each of the corresponding function blocks should be defined.

(5) Reference Point 5: Interfaces for Creating Data Flow and Sending/Receiving User Data

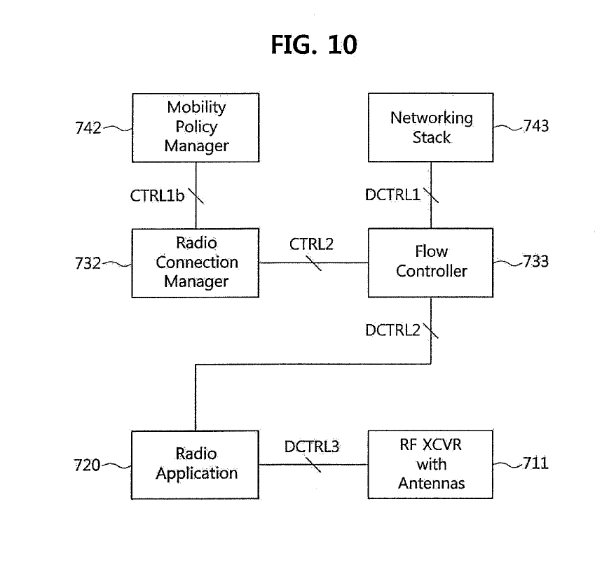

FIG. 10 is a diagram illustrating reference points for creating data flow and sending/receiving user data according to an exemplary embodiment of the present invention.

Referring to FIG. 10, CTRL1b is an interface between MPM and RCM, which is for MPM to request RCM to form data flow or network association with peer equipment, or for MPM to receive response of the request from RCM.

Reference Point CTRL2 is an interface between RCM and FC, which is for RCM to request FC to form data flow, or for RCM to receive response of the request from FC.

Reference Point DCTRL1 is an interface between FC and Networking stack, which is for FC to receive/transfer user data from/to Networking stack for the procedure of sending/receiving data. It also includes an acknowledgement of transmit user data from FC to Networking stack upon completion of sending data. It also includes an acknowledgement of transmit user data from FC to Networking stack upon completion of sending data.

Reference Point DCTRL2 is an interface between FC and RA, which is for FC to transfer the transmit user data to RA and to request RA to transfer the information of transmit user data such as throughput, data bandwidth, etc. to FC. DCTRL2 interface is also used for FC to receive response of the request from RA. In the case of the procedure of receiving data, DCTRL2 interface is used to transfer the receive user data from RA to FC.

Reference Point DCTRL3 is an interface between RA and RF transceiver (XCVR) with antenna(s), which is for RA to receive/transfer receive/transmit user data from/to RF XCVR with antenna.

Software Architecture of MURI

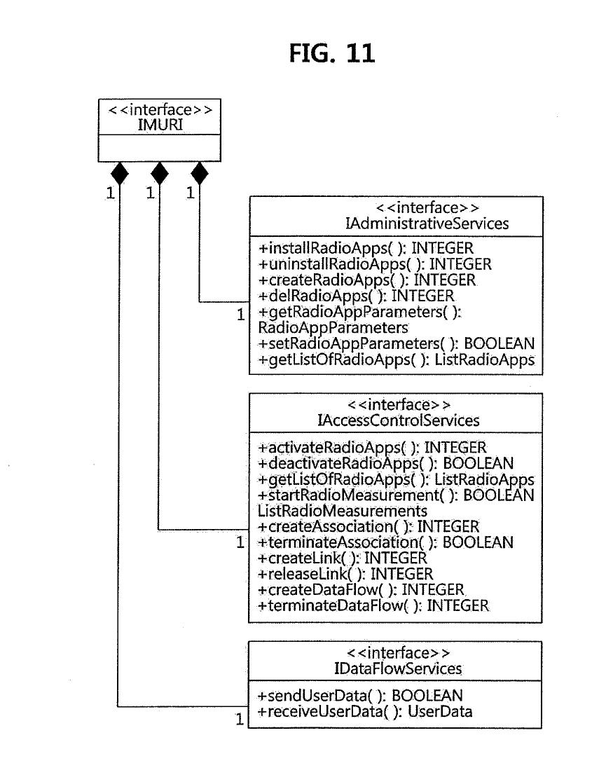

FIG. 11 is a block diagram explaining a configuration example of components and interface objects constituting a MURI according to an exemplary embodiment.

In FIG. 11, the MURI is represented by using a unified modeling language (UML). The terminal apparatus according to the present invention may comprise the MURI for using a multi radio application independently on hardware, and the MURI may be provided as a multi radio subsystem. As shown in FIG. 11, basically, the MURI may support three services including an administrative service, an access control service, and a data flow service, and control the multi radio application through these services. Respective services are classified into an administrative service subsystem, an access control service subsystem, and a data flow service subsystem.

(1) Administrative Service

The administrative service provides following functions with respect to a RA.
A function of installing a RA to a radio computer (terminal apparatus) from a RAP provided in a radio app store, and uninstalling the installed RA from the radio computer.
A function of creating or deleting an instance of a RA
A function of obtaining status information and list information of RAs installed in a mobile device (terminal apparatus)

Also, the CSL and the RCF may exchange following information through the administrative service.

First, the administrative service may transfer following information from the CSL to the RCF.
A request of installation or uninstallation of a RA
A request of creating or deleting an instance of a RA
A request of getting or configuring parameters of a RA
A request of list information of installed RAs, instantiated RAs, and activated RAs.

Second, the administrative service may transfer following information from the RCF to the CSL.
Confirmation of installation or uninstallation of a RA
Confirmation of creation or deletion of a RA instance
Failure of installation or uninstallation of a RA
Failure of creation or deletion of an instance of a RA
Information of parameters of a RA
Retrieved list information of RAs

(2) Access Control Service

The access control service provides following functions with respect to a RA.
A function of activating or deactivating a RA
A function of monitoring radio environments of a mobile device (terminal apparatus)
A function of providing a list of RAs
A function of discovering a peer equipment in order to establish a network connection with another device
A function of instructing to establish a network association for data sending/receiving

Also, the CSL and the RCF may exchange following information through the access control service.

First, the access control service may transfer following information from the CSL to the RCF.
A request of activation or deactivation of a RA
A request of list information of installed RAs, instantiated RAs, and activated RAs
A request of starting or stopping measurements for radio environments
A request of measurements for terminal apparatus capabilities

A request of creating a data flow
A request of creating a network and logical radio link association Second, the access control service may transfer following information from the RCF to the CSL.
Confirmation of activation or deactivation of a RA
Confirmation of data flow creation
Confirmation of creation of a network and logical radio link association
Failure of a RA activation or deactivation
Failure of data flow creation
Failure of creation of a network and logical radio link association
Retrieved list information of RAs
Information related to radio environments
Information on terminal apparatus capabilities

(3) Data Flow Service

The data flow service provides means for transmitting/receiving user data. Also, the data flow service provides following functions.
A function of sending user data at a terminal apparatus
A function of receiving user data at a terminal apparatus

Also, the CSL and the RCF may exchange following information through the data flow service.

First, the data flow service may transfer following information from the CSL to the RCF.
A request of user data transfer

Second, the data flow service may transfer following information from the RCF to the CSL.
Confirmation of user data transfer
Failure of user data transfer

Software architecture of radio processor layer In the above descriptions, overall software architecture and operation environment of radio applications according to the present invention were explained. Hereinafter, provided are further detail explanations operational structures of radio applications within the RP layer.

If a RAP is downloaded, user-defined function block code and radio library which should operate on the RP layer are installed so that they can be accessed in the RP layer.

Hereinafter, codes for configuring components which should be executed on the RP layer, including the above-described user-defined function block code, may be referred to as configuration code (or, ‘configcodes’). Configcodes may include only user-defined function block code, or may include radio library as well as the user-defined function block code. Configcodes may be in form of executable codes or Intermediate Representation (IR).

Also, hereinafter, a real radio platform is defined as a target radio platform, and a concept of a shadow radio platform is defined as a virtual entity having hardware abstraction on the target radio platform. That is, a shadow radio platform may mean a virtual radio platform into which developers of radio applications virtualize an operation environment of radio applications. For example, a shadow radio platform may be equal to or different from a target radio platform. If the Shadow radio platform is different from the target radio platform, the shadow radio platform may be understood as an abstract device independent of hardware. That is, the shadow radio platform may be a radio virtual machine (RVM).

If the shadow radio platform is different from the target radio platform so that the shadow radio platform becomes RVM, the RVM performs virtualization functions for helping the above-described configcodes to operate on the actual target radio platform. The implementation may include the Back-end Compiler which might provide Just-in-Time (JIT) or Ahead-of-Time (AOT) method for compilation of configcodes into executable codes of the target radio platform.

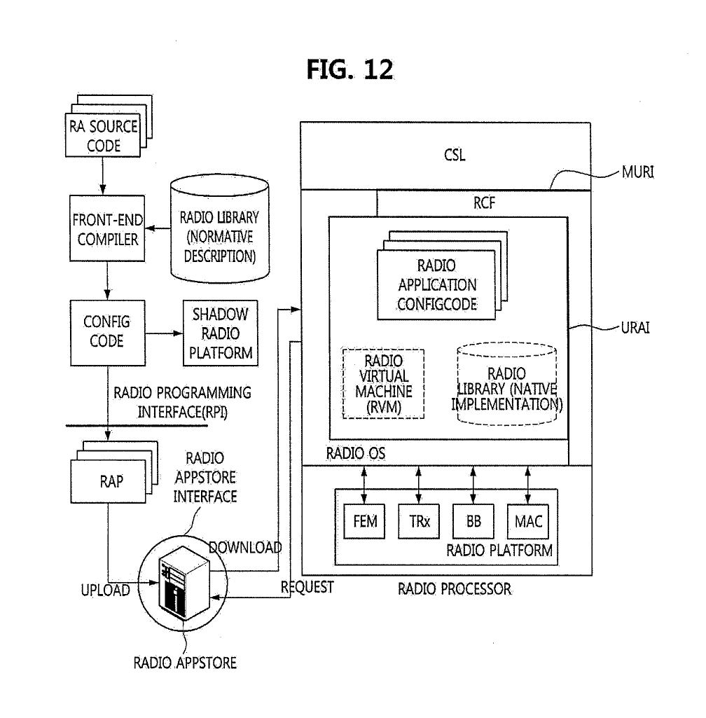

FIG. 12 is a conceptual diagram to explain a RP layer software architecture of radio applications according to the present invention.

The RP provides a mobile device with communication capabilities, and the software architecture for RP, which is illustrated in FIG. 12, may be configured to comprise the following components.
Radio OS
The RP layer part of RCF (when RCF is configured with the RP layer part and the AP layer part), or the entire RCF (when RCF is configured to operation only on the RP).
The CSL when RCF operates only on the RP (Although the CSL is illustrated as operating only on the RP in FIG. 4, the CSL may operate on the AP when RCF is configured to operate on both the RP and the AP).
Implementation of RVM when the shadow radio platform is RVM.
Native implementation of radio library (Radio Lib) when the shadow radio platform is RVM.
Configuration codes (configcodes) of radio applications—configcodes may be provided in form of executable codes of the target radio platform or platform-independent intermediate representation.

The configcodes are interpreted by RVM when the shadow radio platform is equal to RVM, or are equal to executable codes when RVM is equal to the target radio platform.

The RCF and its interfaces such as MURI and URAI have been already explained.

The shadow radio platform can be either RVM or a target radio platform. If the Shadow radio platform is equal to the target radio platform, then front-end compiler will generate executable code for the target radio platform and configcodes is equivalent to the executable code for that radio platform.

The RVM is an abstract machine which is capable of executing configcodes. It is independent of the hardware. The configcodes are executed on a target platform through a specific RVM. Thus, RVM includes a back-end compiler which might provide Just-in-Time (JIT) or Ahead-of-Time (AOT) method for compilation of configcodes into executable codes.

The radio library consists of function blocks representing the computational basis. The radio application can be expressed as a set of these interconnected function blocks. Function blocks of the radio library are represented in the normative language of the radio platform. The native implementation of the radio library provides executable codes of function blocks from the library for the target platform. The radio library is extendable.

Operational Structure of Unified Radio Applications

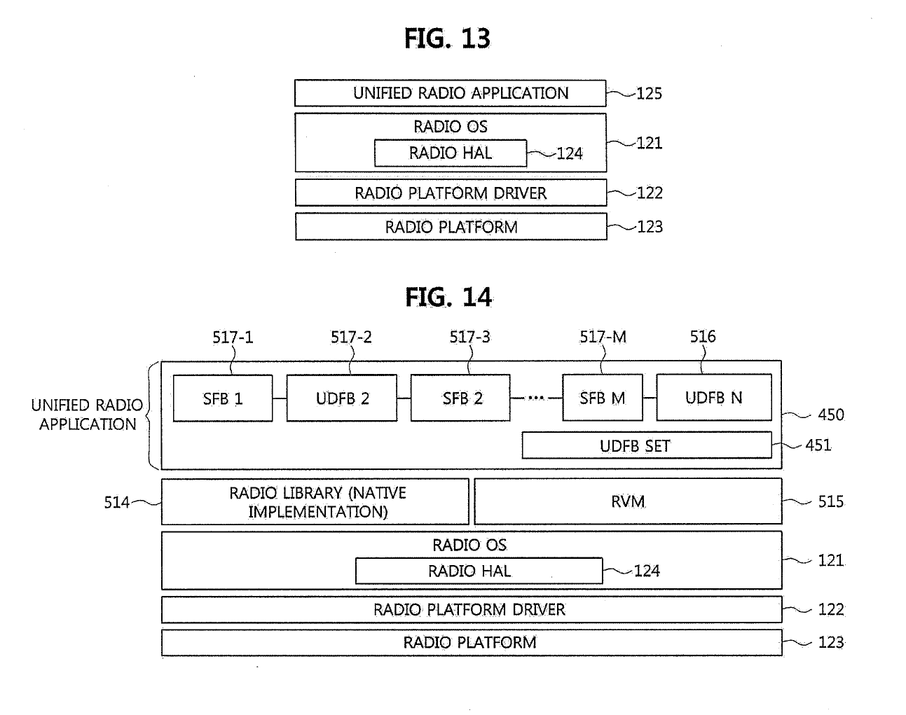

Operational structure of unified radio applications may be represented considering two different cases. One case is when RA configcodes are executable on a target radio platform (illustrated in FIG. 13) and the other case is when RA configcodes are Intermediate Representation (IR) that is to be back-end compiled at a given mobile device (illustrated in FIG. 14).

FIG. 13 and FIG. 14 are hierarchical structure diagrams to explain different examples of operational structures of unified radio applications according to an exemplary embodiment of the present invention.

Referring to FIG. 13, a radio and user-defined function blocks (UDFB) library needed for execution of a given RA are included in executable configcodes of the RA.

Meanwhile, referring to FIG. 14, user-defined function blocks needed for execution of a given radio application are included in the configcodes of the radio application, and should be back-end compiled by RVM shown in FIG. 12. In this case, since the radio library cannot be included in the radio application configcodes, a native implementation of the radio library should be additionally prepared in a given mobile device. Usually the native implementation of the radio library is provided by a core chip vendor because the radio library includes standard function blocks (SFB) implemented on the core processor.

Basically, the radio library (i.e. native implementation), which can be implemented without dedicated hardware accelerator(s) illustrated in FIG. 13 and FIG. 14, are necessary for enhancing speed of the standard function blocks and for generating other standard function blocks by combining accelerator(s) and program codes.

For both a case when the radio application configcodes are executable codes and a case when the radio application configcodes are intermediate representation, the standard function blocks are supported by dedicated hardware logic accelerator(s) through the radio hardware abstract (HAL) layer shown in FIG. 13 and FIG. 14. That is, every time when the standard function blocks implemented using dedicated hardware logics are called by given radio application codes, the standard function blocks should be executed on the corresponding dedicated hardware logic accelerator(s) through the radio HAL, regardless of whether the radio application configcodes are executable codes or intermediate representation. As explained later, the radio HAL also includes hardware abstraction for interfaces prepared for user-defined function block library(s).

The standard function blocks may be function blocks which are commonly used by various radio applications, for example, a Fast Fourier Transform (FFT) block. Also, the standard function blocks may be function blocks which should be efficiently implemented using a special purpose accelerator in a given radio platform, for example, a turbo coder block.

On the other hand, a standard function block set (UDFB set) shown in FIG. 14 includes all user-defined function blocks which are used by given radio application(s). It is important that any standard function block can be modified and/or extended by replacing it with a proper standard function block which is a modified and/or extended version of the standard function block to be replaced. Therefore, some user-defined function blocks can be good candidates for standard function block extension, which means they might be added as standard function blocks later. In that case, after addition, they will become atomic as the normal standard function blocks. Since the user-defined function block Set (UDFB set) is to be provided by radio application provider, i.e. 3rd party, instead of radio platform vendor, in order for radio control framework to be able to perform basic controls of every UDFB's event and/or command, a standard set of control interfaces such as “start”, “stop”, “pause”, “get_port” and “initialize” may have to be specified for the corresponding user-defined function blocks. For this purpose, an ETSI RRS may specify a standard set of control interfaces for each user-defined function block to be implemented properly via the standard set of control interfaces. Specification of the standard control interfaces for user-defined function blocks may be given in the document of Protocol/Interface technical specification (TS). The radio platforms shown in FIGS. 13 and 14 generally comprise both core(s) and dedicated hardware accelerator(s) for implementing each of function blocks.

As shown in FIG. 14, the operational structure of unified radio applications may comprise the following components.
The RA includes SFB(s) and UDFB(s) in accordance with the contents of metadata in a given RAP. Baseband Interface (BBI) represents each function block itself by specifying the name of the corresponding function block. Also, BBI specifies interface related to the corresponding function blocks as mentioned earlier.
Radio Library (normative implementation) contains configcodes of SFBs that are to be implemented on core processor(s) while the SFBs that are to be implemented using dedicated hardware logic accelerator(s) are supported by Radio HAL.
UDFB Set includes all the UDFBs to be used in a given RAP and is in general provided by RA provider. UDFB is included in RAP together with metadata and RC code. Since UDFB is generally a modified and/or extended version of SFB, UDFB may have a dependency on SFB library(-ies).
The radio HAL is to abstract radio platform. The radio HAL supports SFB to be implemented using dedicated hardware logic accelerator in order for each of those SFBs to be implemented directly on corresponding dedicated hardware logic accelerator(s).
The radio platform driver is for the radio OS to recognize the radio platform.
The radio platform in general consists of both core(s) and dedicated hardware accelerator(s).

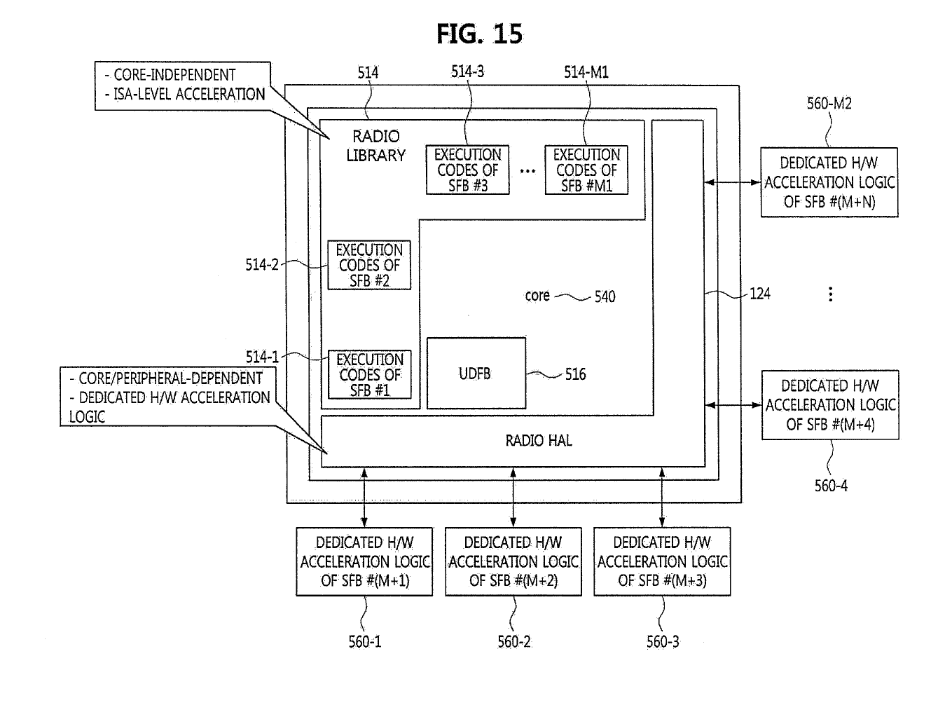

FIG. 15 is a conceptual diagram to explain implementations of function block libraries of a given radio platform according to the present invention. Referring to FIG. 15, illustrated are implementations of function blocks on a given radio platform which consists of core(s) and various kinds of peripheral devices.

In the example shown in FIG. 15, the number of standard function blocks implemented on a core processor has been set to M and the number of standard function blocks implemented on dedicated hardware logic accelerators has been set to N. As mentioned earlier, standard function blocks to be implemented using dedicated hardware logic accelerator such as FFT, Turbo decoder, Multi-Input-Multi-Output (MIMO) decoder, etc. can be implemented directly on the corresponding dedicated hardware logic accelerator for high performance and low power consumption. Those standard function blocks are supported by the radio HAL for implementation on the dedicated accelerator(s). This means that, when each of standard function blocks to be implemented on the dedicated accelerator is called in a radio application, it is executed directly on the corresponding dedicated accelerator through the radio HAL. Similarly, when each of standard function blocks to be implemented on core processor such as bit-reverse, multiply and accumulation, etc., is called in RA, it is executed on a given core (e.g. ARM with Neon).

Consequently, the execution codes required on a radio processor consists of the following two parts. One part is execution codes for standard function blocks executed on programmable core(s) and the other part is radio HAL codes for standard function blocks implemented on dedicated accelerators.

This can be summarized as follows. {C: execution code required on RP for SFB implementation}={A: execution codes for SFBs implemented on programmable cores}+{B: Radio HAL codes for SFBs implemented on accelerators}. That is, C=A+B where A and B may be determined by each vendor.

This may also mean that {SFBs} is a union of {SFBs implemented on core processor} and {SFBs implemented on dedicated hardware accelerators}, and an intersection of {SFBs implemented on core processor} and {SFBs implemented on dedicated hardware accelerators} is an empty set.

Meanwhile, UDFB, as mentioned earlier, should be written with standard interfaces. As shown in FIG. 15, it should be observed that the standard interfaces of UDFB might be associated with either SFB(s) implemented on core processor or SFB(s) implemented on dedicated hardware accelerator, or both.

The reason why we classify standard interfaces into two groups, i.e. the one corresponding to SFB(s) implemented on core processor and the other corresponding to SFB(s) implemented on dedicated hardware accelerator, is that each category has its own pros and cons. The latter, since it is implemented on dedicated hardware logic, is advantageous for power consumption, speed-up operation, and, probably, cost-effectiveness. On the contrary, the former, since it is implemented on microprocessor, is advantageous mainly for flexibility. It is expected that the dedicated hardware accelerator(s) will be used relatively more widely at the beginning stage until programmable devices become competitive to dedicated hardware devices in performance. As semiconductor technology evolves more and more, the core-dependent SFB will gradually become more and more dominant compared to the core-and-peripheral-dependent SFB in a long term standpoint and be implemented via Instruction Set Architecture (ISA)-level acceleration.

The granularity of the standard function blocks shown in the present specification are just for the purpose of explanation, and the standard function block interfaces may be defined in other documents, as mentioned earlier.

Composition of Radio Application Package (RAP)

Hereinafter, composition of a radio application package (RAP) for distribution of a radio application according to the present invention will be explained in detail.

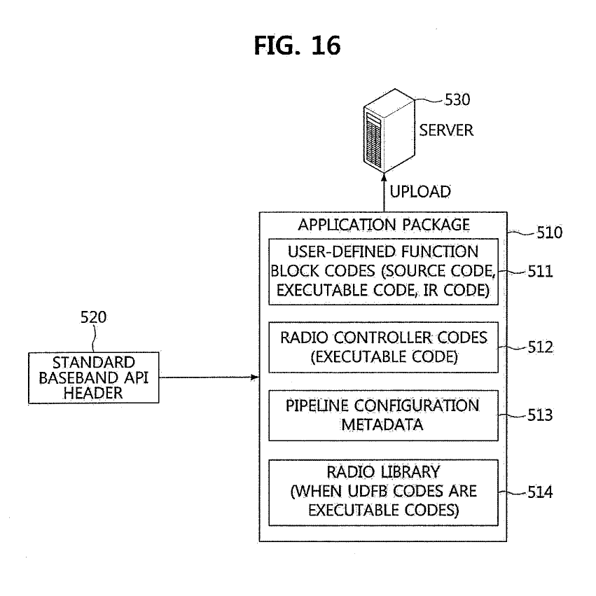

FIG. 16 is a block diagram to explain a configuration example of a radio application package according to the present invention.

As explained earlier, a RA according to the present invention may comprise function blocks and a radio controller, and a RAP 510 may be configured to comprise user-defined function block codes 511, radio library, and radio controller codes 512 for them. Thus, the RAP for distribution of radio application may basically comprise user-defined function block codes 511 and radio controller codes 512. Also, it may further comprise pipeline configuration metadata 513.

The radio controller codes may be determined to be included in the RAP in executable code form of either the RP or the AP according to the above-described software architecture environment. That is, if the RCF is divided into the AP layer part and the RP layer part, the radio controller codes may be configured as codes executable on the AP. Otherwise, if the RCF is executed only on the RP, the radio controller codes may be configured as codes executable on the RP. Meanwhile, the user-defined function block codes are codes which always operate on the RP, and so the RAP may include the user-defined function block codes in executable code form of the radio processor, in source code form, or in IR form.

A pipeline means a combination of radio controller, user-defined function blocks, and standard function blocks for implementing transmission or reception functions of the RA and their relations, and may be defined based on the pipeline configuration metadata.

Also, if the standard function block codes are configured as codes executable on cores of the RP, the RAP 510 may be configure to further comprise radio library 514 in executable code form (executable code of the radio processor cores) as explained earlier.

The RAP 510 may be downloaded from a server 530 onto the OS of the AP layer, and the user-defined function block codes 512 and the radio library 514 may be loaded from the AP to the RP by referring to the pipeline configuration metadata, and finally loaded to the radio OS on the RP layer.

The description may be merely an example of the scope of the invention, and one of ordinary skill in the art to which this invention belongs may make various changes, substitutions, and alterations without departing from the scope of the invention. Accordingly, there is no intent to limit the invention to the embodiments disclosed, and the scope of the invention is not limited to the embodiments. The scope of the invention may be interpreted by the following claims, and every technical spirit within its equivalent range may be interpreted as being included in the scope of the invention.

1. A terminal apparatus which executes a radio application (RA) and includes an application processor (AP) and a radio processor (RP), the terminal apparatus comprising:
a communication service layer (CSL) operating on the AP or the RP, and providing at least one of an administrative service, an access control service, and a data flow service for the RA;
a radio control framework (RCF) operating on both of the AP and the RP or on the RP, and providing operation environments for the RA by interworking with the CSL; and
a multi radio interface (MURI) for interworking of the CSL and the RCF.

2. The terminal apparatus according to claim 1, wherein the MURI is provided as a multi radio subsystem.

3. The terminal apparatus according to claim 1, wherein the CSL comprises at least one of:
an administrator performing at least one of installation/uninstallation of the RA, creating/deleting an instance of the RA, and a request of list information and status information of RAs;
a mobility policy manager (MPM) monitoring capabilities and radio environments of the terminal apparatus, and selecting at least one of two or more radio access technologies (RATs);
a networking stack sending and receiving user data; and
a monitor transmitting context information.

4. The terminal apparatus according to claim 1, wherein the RCF comprises at least one of:
a configuration manager (CM) performing installation/uninstallation of the RA, creating/deleting an instance of the RA, and access management of radio parameters for the RA;
a radio connection manager (RCM) performing activation/deactivation of the RA and management of user data flow switching between RAs;
a flow controller (FC) controlling sending/receiving and a flow of user data packets;
a multi-radio controller (MRC) scheduling requests for spectrum resources issued by the RA; and
a resource manager (RM) managing radio resources to share them among RAs.

5. The terminal apparatus according to claim 1, wherein the MURI comprises at least one of:
an administrative service performing management of the RA,
an access control service controlling activation/deactivation of the RA; and
a data flow service providing a function of transferring user data of the terminal apparatus or user data received at the terminal apparatus.

6. The terminal apparatus according to claim 5, wherein the administrative service transfers a request of installation or uninstallation of the RA from the CSL to the RCF, transfers confirmation for the request of installation or uninstallation from the RCF to the CSL, and controls the RCF to install or uninstall the RA based on the request of installation or uninstallation.

7. The terminal apparatus according to claim 6, wherein the administrative service transfers at least one of a request of creating or deleting an instance of the RA, a request of parameter configuration, and a request of list information of RAs from the CSL to the RCF, and transfers at least one of confirmation for the request of creating or deleting an instance of the RA, confirmation of the request of parameter configuration, retrieved list information, and information indicating a failure for the at least one request from the RCF to the CSL.

8. The terminal apparatus according to claim 5, wherein the access control service transfers a request of activation or deactivation of the RA from the CSL to the RCF, transfers confirmation for the request of activation or deactivation from the RCF to the CSL, and controls the RCF to activate or deactivate the RA based on the request of activation or deactivation.

9. The terminal apparatus according to claim 8, wherein the access control service transfers at least one of a request of list information of RAs, a request of measurements for radio environments, a request of measurements for the terminal apparatus capabilities, a request of creating a data flow, and a request of network and logical radio link association from the CSL to the RCF, and transfers at least one of retrieved list information, information on the radio environments, information on the terminal apparatus capabilities, confirmation for the request of creating a data flow, confirmation for the network and logical radio link association, and information indicating a failure of the at least one request from the RCF to the CSL.

10. The terminal apparatus according to claim 5, wherein the data flow service transfers the user data of the terminal apparatus from the CSL to the RCF, or transfers the user data received at the terminal apparatus from the RCF to the CSL.

11. The terminal apparatus according to claim 10, wherein the data flow service transfers information indicating a failure of the user data transfer from the RCF to the CSL.

12. The terminal apparatus according to claim 1, wherein the RA comprises:
standard function blocks (SFBs) which call function blocks implemented using dedicated hardware logics included in the RP or which operate on a core of the RP;
user-defined function blocks (UDFBs) which are not provided as the SFBs or which are customized from functions provided by the SFBs; and
a radio controller code performing a function of transmitting context information to a monitor of the CSL or a function of exchanging data with a networking stack of the CSL.

13. The terminal apparatus according to claim 12, wherein the RA is distributed in a form of a radio application package (RAP) comprising at least one of:
the SFBs;
the UDFBs;
the radio controller code; and
a pipeline configuration meta data defining relations among the SFBs, the UDFBs, and the radio controller code.

14. The terminal apparatus according to claim 13, wherein the RAP further comprises a radio library including the SFBs.

15. A method of executing a radio application (RA), performed in a terminal apparatus including an application processor (AP) and a radio processor (RP), the method comprising:
providing at least one of an administrative service, an access control service, and a data flow service for the RA in a communication service layer operating on the AP or the RP;
providing operation environments for the RA by interworking with the CSL in a radio control framework (RCF) operating on both of the AP and the RP or on the RP; and
providing a multi radio interface (MURI) for interworking of the CSL and the RCF.

16. A multi radio subsystem providing a multi radio interface (MURI) operating in a terminal apparatus executing a radio application (RA),
wherein the MURI provides functions for interworking of a communication service layer (CSL) operating on an application processor (AP) or a radio processor (RP) and a radio control framework (RCF) operating on the AP or the RP,
wherein the CSL provides at least one of an administrative service, an access control service, and a data flow service of the RA for the RA, and
wherein the RCF provides operating environments for the RA by interworking with the CSL.

17. The multi radio subsystem according to claim 16, wherein the multi radio subsystem provides at least one of:
an administrative service performing management of the RA,
an access control service controlling activation/deactivation of the RA; and
a data flow service providing a function of transferring user data of the terminal apparatus or user data received at the terminal apparatus.

18. The multi radio subsystem according to claim 17, wherein the administrative service transfers at least one of a request of installation or uninstallation of the RA, a request of creating or deleting an instance of the RA, a request of list information of RAs, and a request of status information of RAs from an administrator of the CSL to the RCF.

19. The multi radio subsystem according to claim 18, wherein the administrative service controls a configuration manager of the RCF to perform installation or uninstallation of the RA and creation or deletion of an instance of the RA based on the request, and transfers confirmation for the installation, uninstallation, creation, or deletion from the configuration manager to the administrator.

20. The multi radio subsystem according to claim 17, wherein the access control service transfers at least one of a request of list information of RAs, a request of measurements for radio environments, a request of measurements for the terminal apparatus capabilities, a request of creating a data flow, and a request of network and logical radio link association from the CSL to the RCF such that a mobility policy manager (MPM) of the CSL monitors capabilities and radio environments of the terminal apparatus and selects at least one of one or more radio access technologies (RATs).
